(19) United States
(12) Patent Application Publication
(10) Pub. No.: US 2014/0320405 A1
(43) Pub. Date: Oct. 30, 2014

(54) METHOD FOR CONTROLLING PORTABLE TERMINAL BY TOUCH DEVICE

(71) Applicant: QUANTA STORAGE INC., Taoyuan County (TW)

(72) Inventors: Chia-Szu Yu, Taoyuan County (TW); Shih-Te Yang, Taoyuan County (TW); Wen-Jing Lin, Taoyuan County (TW)

(73) Assignee: QUANTA STORAGE INC., Taoyuan County (TW)

(21) Appl. No.: 14/195,817

(22) Filed: Mar. 3, 2014

(30) Foreign Application Priority Data
Apr. 24, 2013 (CN) 201310145296.1

(51) Int. Cl. G06F 3/0354

(52) U.S. Cl. CPC G06F 3/03547
USPC 345/157

(57) ABSTRACT

A method for controlling a portable terminal by a touch device includes the following steps: connecting the touch device to the portable terminal, and recording a screen resolution of the portable terminal; displaying the same image on respective screens of the touch device and the portable terminal synchronously; resetting respective cursors on the respective screens to corresponding reference points concurrently; detecting an absolute coordinate of the cursor on the screen of the touch device in response to a press operation performed upon the screen of the touch device; calculating a relative displacement between the absolute coordinate and the corresponding reference point; transforming the relative displacement into a corresponding relative coordinate of the cursor of the portable terminal; transmitting the corresponding relative coordinate to the portable terminal over a wireless link; controlling the cursor of the portable terminal according to the corresponding relative coordinate; and resetting the respective cursors concurrently.

### BACKGROUND OF THE INVENTION

1. Field of the Invention

The disclosed embodiments relate to a portable terminal control method, and more particularly, to a method for controlling a portable terminal intuitively by using a cursor of a touch device.

2. Description of the Prior Art

Nowadays, a portable terminal (e.g. a mobile phone or a tablet computer) may run more and more applications such as audio/video content playback, web browsing, gaming, and navigation. An emerging trend is to connect a powerful portable terminal to a large size television having weaker performance in order to enhance a viewing experience and game play experience, or connect the powerful portable terminal to an on-board unit in order to listen to music and perform navigation functions. However, when a touch device (e.g. a large size television or an on-board unit) is connected to the portable terminal, a user has to operate the portable terminal directly in order to run applications or switch to different screens. In other words, the user cannot operate the portable terminal by controlling the touch device intuitively. When the user has to operate a portable terminal in driving a vehicle, it will lead to a dangerous driving.

Please refer to FIG. 1, which is diagram illustrating a conventional touch device 10 used to control a portable apparatus 11. When the touch device 10 (e.g. an on-board unit) is connected to the portable apparatus 11, the touch device 10 and the portable apparatus 11 can display an icon 12 on respective screens (i.e. a screen 13 of the touch device 10 and a screen 14 of the portable apparatus 14) synchronously by means of a specific application (APP) provided by a car dealer. When a user taps the icon 12 on the screen 13 of the touch device 10, an activation signal of the icon 12 is generated to activate the icon 12 corresponding to the portable terminal 11. Hence, the user may execute functions of the portable terminal 11 (e.g. a music listening or a navigation function) via the equipment of the touch device 10 (e.g. the screen 13 or speakers), thus avoiding a dangerous driving condition.

However, the specific application provided by the car dealer may be only applicable to a link between a car sold by the car dealer and a mobile phone of a specific model. In a case where the specific application is not applicable, as a touch device in a vehicle and a portable terminal (e.g. an Android phone) have different screen resolutions or have limitations on cursor coordinate reception, the portable terminal will receive relative cursor coordinates only. For example, when the user taps the screen 13 of the touch device 10, a relative displacement D between a cursor 15 and a cursor 16 is transmitted to the screen 14 of the portable terminal 11 in a wireless manner, and a cursor 17 is moved to a cursor 18 accordingly. As a position of the cursor 18 deviates from an expected position, operations on the screen 13 of the touch device 10 fails to open a corresponding application of the portable terminal 11. Hence, in order to open applications, the user has to look at the portable terminal 11 rather than operate the touch device 10 intuitively, resulting in inconvenience and a dangerous driving condition. Thus, controlling a portable terminal using a touch device is a problem that still needs to be solved.

### SUMMARY OF THE INVENTION

It is one objective of the present invention to provide a method for controlling a portable terminal by a touch device. By means of cursor operation corresponding to absolute coordinates of the touch device and relative coordinates of the portable terminal, intuitive operations on the touch device can activate functions of the portable terminal.

It is another objective of the present invention to provide a method for controlling a portable terminal by a touch device. By transforming absolute coordinates of a cursor of the touch device into displacements of relative coordinates of the portable terminal and transmitting the displacements, the application scope of the portable terminal is extended.

It is yet another objective of the present invention to provide a method for controlling a portable terminal by a touch device. After a press operation upon a touch screen of the touch device is completed, correctness of following operations is ensured by resetting respective cursors of the touch device and the portable terminal to corresponding reference points.

It is still another objective of the present invention to provide a method for controlling a portable terminal by a touch device. According to a tapping press and a slide-and-press upon a touch screen of the touch device, the slide-and-press can correct a press position or move an icon.

In order to achieve the above objectives, the present invention provides a method for controlling a portable terminal by a touch device. The method for controlling the portable terminal by the touch device comprises the following steps: connecting the touch device to the portable terminal, and using the touch device to record a screen resolution of the portable terminal; displaying the same image on a screen of the touch device and a screen of the portable terminal synchronously; resetting respective cursors on the screens of the touch device and the portable terminal to corresponding reference points; detecting an absolute coordinate of the cursor on the screen of the touch device in response to a press operation performed upon the screen of the touch device; calculating a relative displacement between the absolute coordinate of the cursor and the corresponding reference point; transforming the relative displacement into a corresponding relative coordinate of the cursor on the screen of the portable terminal according to a ratio between a screen resolution of the touch device and the screen resolution of the portable terminal; transmitting the corresponding relative coordinate to the portable terminal over a wireless link; controlling the cursor on the screen of the portable terminal according to the corresponding relative coordinate; and resetting the respective cursors on the screens of the touch device and the portable terminal to the corresponding reference points before a next press operation.

In the present invention, the press operation is a press-and-slide or a tapping press. A start point and an end point of the press-and-slide correspond to different absolute coordinates on the screen of the touch device. A start point and an end point of the tapping press correspond to the same absolute coordinate on the screen of the touch device. It is determined whether the press operation is the press-and-slide according to absolute coordinates of a start point and an end point of the press operation. Regarding the tapping press, a slide displacement is calculated according to the absolute coordinates of the start point and the end point, and transformed into a slide relative coordinate of the cursor on the screen of the portable terminal according to the ratio between the respective screen resolutions of the touch device and the portable terminal. The slide relative coordinate is transmitted to the portable terminal over a wireless link. After the cursor on the screen of the portable terminal is controlled to move to a position according to the corresponding relative coordinate, the cursor on the screen of the portable terminal is moved from the position according to the slide relative coordinate. Additionally, the respective cursors on the screens of the touch device and the portable terminal are reset to the corresponding reference points before a next press operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is diagram illustrating a conventional touch device used to control a portable apparatus.

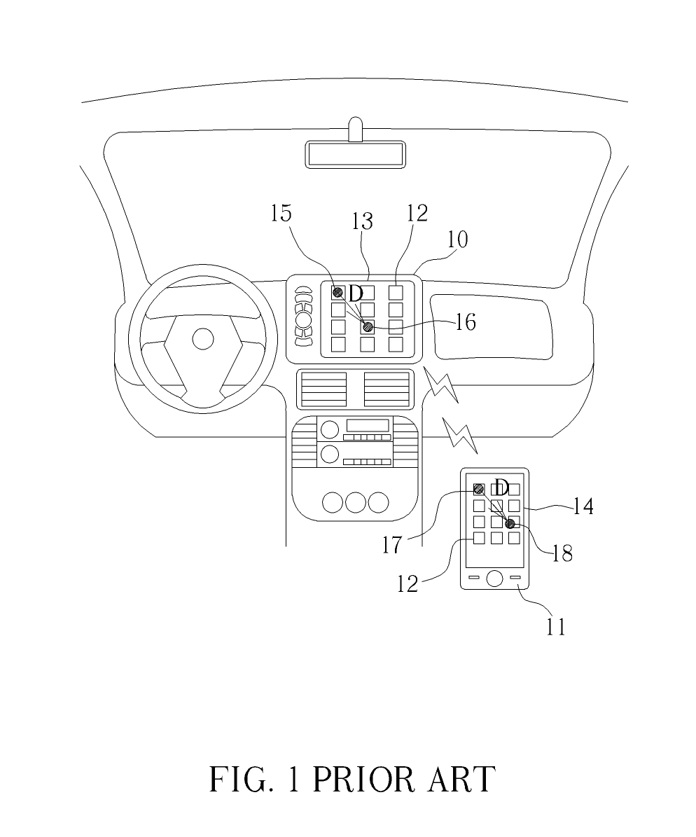

FIG. 2 is a diagram illustrating cursor operations of an exemplary touch device and an exemplary portable apparatus according to an embodiment of the present invention.

FIG. 3 is a diagram illustrating exemplary cursor movements of a touch device and a portable terminal according to a first embodiment of the present invention.

FIG. 4 is a flowchart of an exemplary method for controlling a portable terminal by a touch device according to a first embodiment of the present invention.

FIG. 5 is a diagram illustrating exemplary cursor movements of a touch device and a portable terminal according to a second embodiment of the present invention.

FIG. 6 is a diagram illustrating exemplary cursor movements of a touch device and a portable terminal according to a second embodiment of the present invention.

FIG. 7 is a flowchart of an exemplary method for controlling a portable terminal by a touch device according to a second embodiment of the present invention.

### DETAILED DESCRIPTION

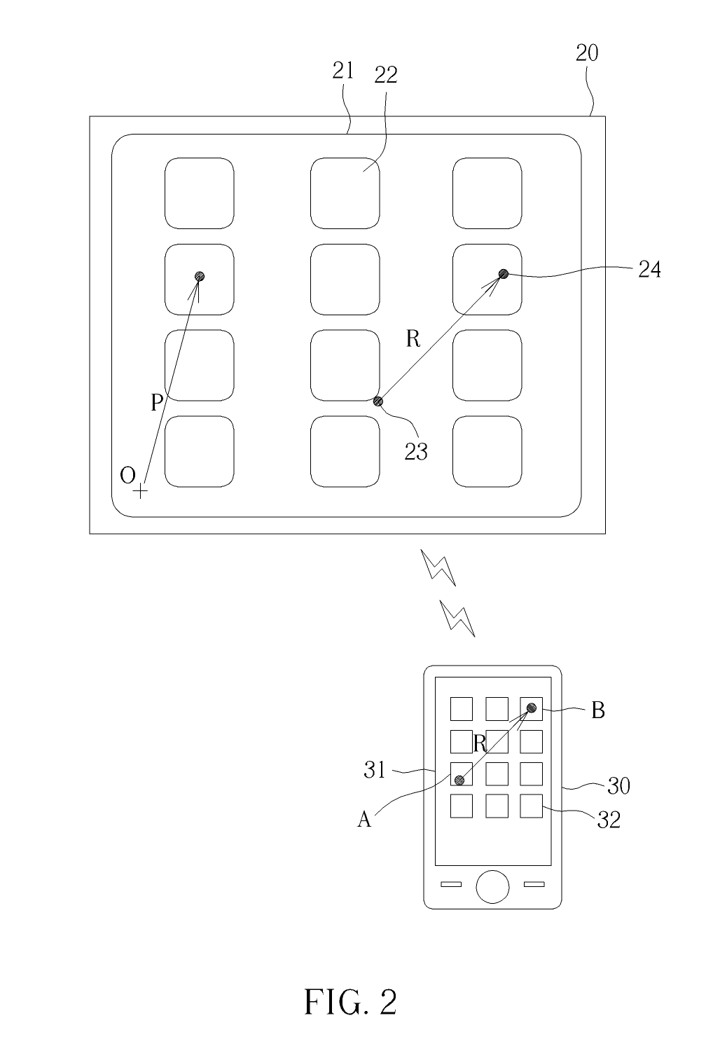

Please refer to FIG. 2, which is a diagram illustrating cursor operations of an exemplary touch device 20 and an exemplary portable apparatus 30 according to an embodiment of the present invention. By way of example but not limitation, the touch device 20 may be a device including a touch screen 21 (e.g. a large size television or an on-board unit), and the portable terminal 30 may be a portable apparatus such as a mobile phone or a tablet computer. After the touch device 20 and the portable terminal 30 are connected, the touch screen 21 of the touch device 20 and a screen 31 of the portable terminal 30 may display the same image synchronously. As executable files for activating applications of the portable terminal 30 are stored in the portable terminal 30 rather than the touch device 20, pressing an icon 22 of the touch device 20 cannot activate an application corresponding to the icon 22. Hence, the connected touch device 20 is actually used as a mouse of the portable terminal 30, and transmits a cursor movement signal over a bluetooth or wireless link. For example, a standard bluetooth transmission transmits relative coordinates associated with a cursor movement of the touch device 20, wherein the cursor movement is used to control a cursor of the portable terminal 30.

Consider a case where a user wants to switch to an application corresponding to one of icons 32 of the portable terminal 30 (e.g. moving a cursor staying at an icon A to an icon B). As a cursor of the portable terminal 30 moves according to relative coordinates of a cursor of the touch device 20, and the cursor moving from the icon A to the icon B on the screen 31 has a relative displacement R, the cursor of the portable terminal 30 may be moved to the icon B as long as the cursor of the touch device 20 has the relative displacement R (e.g. moving a cursor 23 to a position of a cursor 24 on the touch screen 21). Hence, the user may activate the icon B. Briefly, in order to control the portable terminal 30 to activate the icon B, the user has to watch the screen 31 to ensure that the cursor of the portable terminal 30 is moved to the icon B.

Consider another case where the cursor of the portable terminal 30 moves according to absolute coordinates of the cursor of the touch device 20, wherein the cursor of the touch device 20 is moved from an origin point. When a user presses an icon having an absolute coordinate P, cursor movements of the touch device 20 and the portable terminal 30 are different due to different screen resolutions. In addition, wireless links of certain mobile phones (e.g. widely used Android phones) receive cursor movements associated with relative coordinates rather than absolute coordinates. The cursor operation employing absolute coordinates is not applicable to most mobile phones and therefore has limited application.

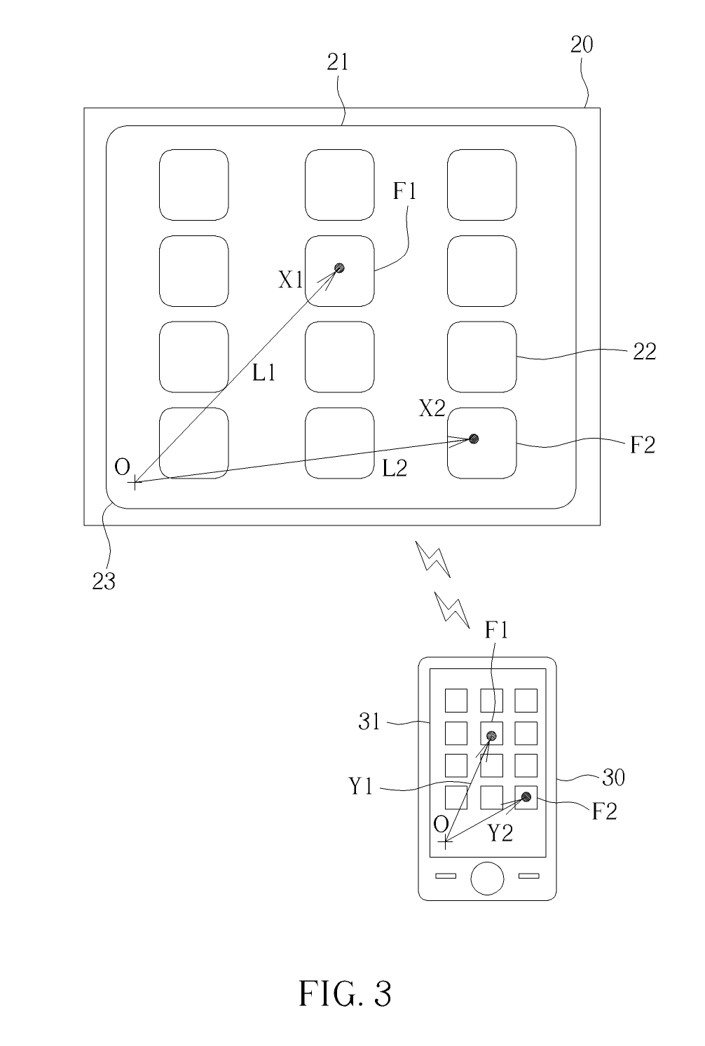

Please refer to FIG. 3, which is a diagram illustrating exemplary cursor movements of the touch device 20 and the portable terminal 30 according to a first embodiment of the present invention. In order to realize the intuitive operation and extend the application scope, the touch screen 21 of the touch device 20 and the screen 31 of the portable terminal 31 may display the same image synchronously after the touch device 20 and the portable terminal 31 are connected, wherein the touch device 20 may record a screen resolution of the screen 31 of the portable terminal 30 and reset the cursor on the touch screen 21 to a reference point O (e.g. a predetermined start point). Additionally, the touch device 20 may reset the cursor on the screen 31 of the portable terminal 31 to the reference point O over a bluetooth link. Hence, each of the touch device 20 and the portable terminal 30 may obtain the corresponding reference point O, wherein the reference point O may be a predetermined point or a coordinate origin on the corresponding screen.

Next, the touch device 20 may move the cursor thereof according to absolute coordinates in order to perform the press operation upon one of icons 22 intuitively. The touch device 20 may refer to the screen resolutions of the touch device 20 and the portable terminal 30 to transform an absolute coordinate of the cursor thereof into a corresponding relative coordinate of the cursor of the portable terminal 30. In addition, the touch device 20 may transmit the corresponding relative coordinate to the portable terminal 30 over the wireless link, thereby controlling the cursor on the screen 31 of the portable terminal 30 to arrive at a desired icon and hence activate the icon.

After multiple cursor operations, it is difficult to confirm a cursor position so that an operation error is more likely to occur. Hence, each time a press operation is completed (e.g. a user's finger leaves the touch screen 21), the proposed method may reset the cursor on the touch screen 21 of the touch device 20 and the cursor on the screen 31 of the portable terminal 30 concurrently to the corresponding reference points O. When a next operation starts, the cursors of the touch device 20 and the portable terminal 30 may move from the corresponding reference points O, thus ensuring correctness of the operation.

An exemplary procedure of controlling the portable terminal 30 by the touch device 20 according to the first embodiment is described below. After the touch device 20 and the portable terminal 30 are connected, the screen 21 of the touch device 20 and the screen 31 of the portable terminal 30 may display the same image synchronously. The touch device 20 may record the screen resolution of the screen 31 of the portable terminal 30 and reset the cursor on the touch screen 21 to the reference point O. Additionally, the touch device 20 may reset the cursor on the screen 31 of the portable terminal 31 to the reference point O over a bluetooth link. Hence, after the touch device 20 and the portable terminal 30 are connected, the respective cursors of the touch device 20 and the portable terminal 30 may be reset to the corresponding reference points O. When the portable terminal 30 needs to switch to an icon F1, a position corresponding to the icon F1 on the touch screen 21 of the touch device 20 may be pressed intuitively. The touch device 20 may generate an absolute coordinate X1 according to a cursor movement, and calculate a relative displacement L1 of the cursor moving from the reference point O to the absolute coordinate X1.

Next, the touch device 20 may calculate a magnitude and a direction of the relative displacement L1 on the screen 31 of the portable terminal 31 according to the ratio of the screen resolutions of the touch device 20 and the portable terminal 30. The relative displacement L1 of the cursor movement of the touch device 20 may be transformed into a corresponding relative coordinate Y1 of the portable terminal 30, and the corresponding relative coordinate Y1 may be transmitted to the portable terminal 30 over the wireless link. The cursor on the screen 31 of the portable terminal 30 may be moved to the corresponding relative coordinate Y1 (corresponding to the icon F1) from the reference point O, thereby activating the icon F1. Once the press operation is completed (e.g. a user's finger leaves the touch screen 21), the cursors of the touch device 20 and the portable terminal 30 may be reset to the respective reference points O concurrently, thus allowing each of the cursors of the touch device 20 and the portable terminal 30 to move from the corresponding reference point O initially each time an cursor operation is performed.

Similarly, when the portable terminal 30 needs to switch to an icon F2, a position corresponding to the icon F2 on the touch screen 21 of the touch device may be pressed intuitively. The touch device 20 may refer to the cursor, which has been reset to the reference point O, to generate an absolute coordinate X2, and calculate a relative displacement L2 of the cursor moving from the reference point O to the absolute coordinate X2. Next, the touch device 20 may transform the relative displacement L2 of the cursor of the touch device 20 into a corresponding relative coordinate Y2 of the portable terminal 30 according to the ratio of the screen resolutions of the touch device 20 and the portable terminal 30. The corresponding relative coordinate Y2 may be transmitted to the portable terminal 30 over the wireless link. The cursor on the screen 31 of the portable terminal 30 may be moved to the corresponding relative coordinate Y2 (corresponding to the icon F2) from the reference point O, thereby activating the icon F2. Once the press operation is completed (e.g. a user's finger leaves the touch screen 21), the cursors of the touch device 20 and the portable terminal 30 may be reset to the respective reference points O concurrently. In brief, each operation may be regarded as a first operation, thus simplifying calculation and ensuring correctness of the operation.

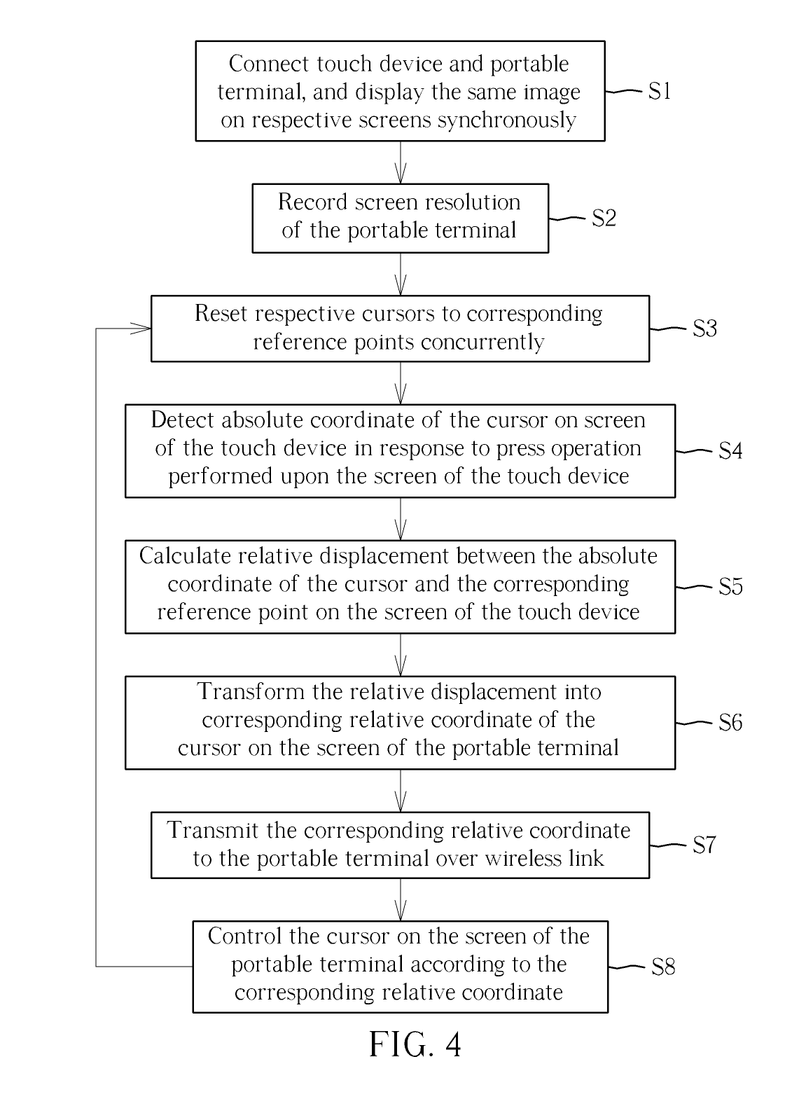

Please refer to FIG. 4, which is a flowchart of an exemplary method for controlling a portable terminal by a touch device according to a first embodiment of the present invention. Steps of intuitively controlling the portable apparatus by the touch device are described in detail below.

Step S1: Connect the touch device and the portable terminal, and display the same image on respective screens of the touch device and the portable terminal synchronously.

Step S2: Use the touch device to record a screen resolution of the portable terminal.

Step S3: Reset respective cursors on the screens of the touch device and the portable terminal to corresponding reference points concurrently.

Step S4: Detect an absolute coordinate of the cursor on the screen of the touch device in response to a press operation performed upon the screen of the touch device.

Step S5: Calculate a relative displacement between the absolute coordinate of the cursor and the corresponding reference point.

Step S6: Transform the relative displacement into a corresponding relative coordinate of the cursor on the screen of the portable terminal according to a ratio between a screen resolution of the touch device and the screen resolution of the portable terminal.

Step S7: Transmit the corresponding relative coordinate to the portable terminal over a wireless link.

Step S8: Control the cursor on the screen of the portable terminal according to the corresponding relative coordinate. Return to step S3 before a next press operation.

By converting the absolute coordinate of the touch device to the corresponding relative coordinate of the portable terminal and transmitting the corresponding relative coordinate to the portable terminal, the proposed method for controlling the portable terminal by the touch device according to the first embodiment of the present invention may extend the application scope of the portable terminal. In addition, by means of cursor operations corresponding to the absolute coordinate of the touch device and the relative coordinate of the portable terminal, the proposed method may achieve the objective of activating the portable terminal by controlling the touch device intuitively. Moreover, by resetting respective cursors on the screens of the touch device and the portable terminal to corresponding reference points synchronously after the press operation performed upon the screen of the touch device is completed, each press operation may be started from the corresponding reference point, thus ensuring the correctness of the control operation.

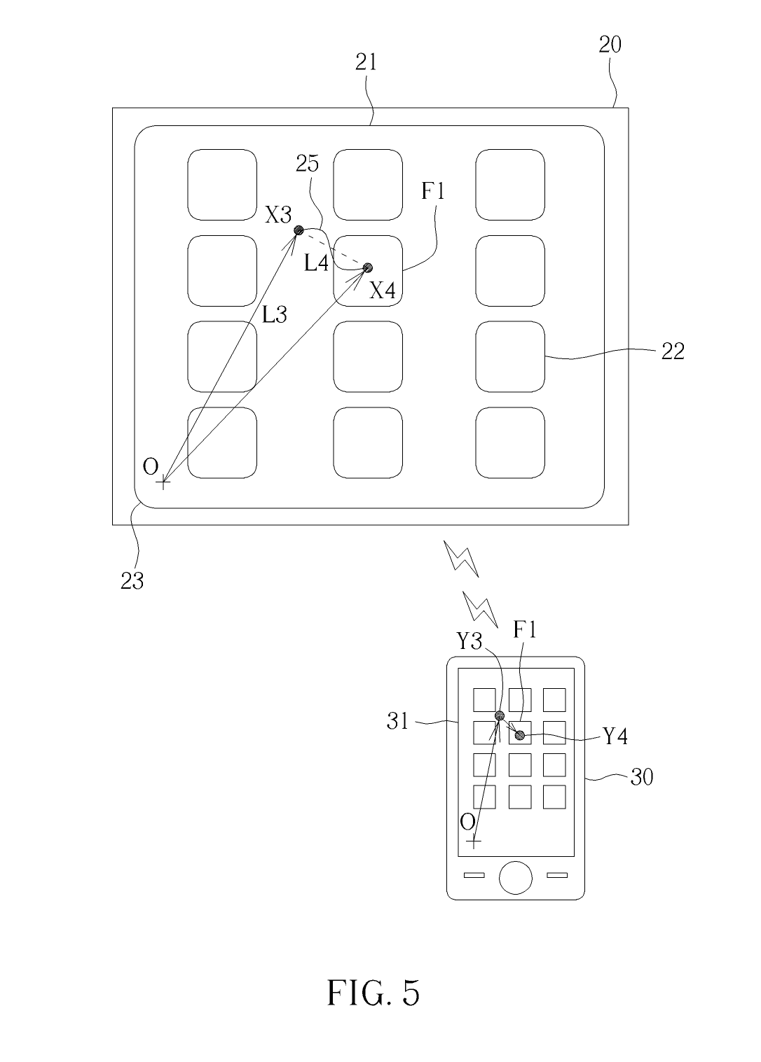

Please refer to FIG. 5, which is a diagram illustrating exemplary cursor movements of a touch device and a portable terminal according to a second embodiment of the present invention. The architecture shown in the second embodiment is identical to that shown in the first embodiment of the present invention. For illustrative purposes, the identical components/elements shown in the first and second embodiments are assigned the same label. The method for controlling a portable terminal involved in the second embodiment is based on that involved in the first embodiment. In this embodiment, a press operation may include a press-and-slide and a tapping press. Regarding a press track 25 of the press-and-slide, a start point and an end point thereof may correspond to different absolute coordinates on the touch screen 21 (e.g. the start point corresponds to an absolute coordinate X3, and the end point corresponds to an absolute coordinate X4); regarding a press track of the tapping, a start point and an end point thereof may correspond to an identical absolute coordinate on the touch screen 21. In a case where a tapping press is performed, the method for controlling a cursor of a portable terminal shown in the second embodiment is identical to that shown in the first embodiment. In a case where a press-and-slide is performed, in addition to executing the steps for controlling a cursor of a portable terminal shown in the first embodiment, the control method may further take into consideration a slide displacement L4 of the cursor sliding from the start point (corresponding to the absolute coordinate X3) to the end point (corresponding to the absolute coordinate X4) in order to correct a press position.

An exemplary procedure of controlling the portable terminal 30 by the touch device 20 according to the second embodiment is described below. After the touch device 20 and the portable terminal 30 are connected, the screen 21 of the touch device 20 and the screen 31 of the portable terminal 30 may display the same image synchronously, and the respective cursors of the touch device 20 and the portable terminal 30 may be reset to the corresponding reference points O. When the portable terminal 30 needs to switch to the icon F1, an object (e.g. a user's finger) may press a position corresponding to the icon F1 on the touch screen 21 of the touch device 20 intuitively. If the icon F1 on the touch screen 21 is pressed (i.e. press position correction is not required), a tapping press is performed. This is identical to the operation of controlling the portable terminal 30 to activate the icon F1 by the touch device 20 described in the first embodiment. If the object presses a position (corresponding to the absolute coordinate X3) near the icon F1 rather than the icon F1, and the object slides to the icon F1 through the press track 25 before leaving the touch screen 21, a slide-and-press is performed.

In a case where a slide-and-press is performed, the first stage of the control mechanism in response to the start point of the press track 25 (i.e. the absolute coordinate X3) is the same as the associated steps described in the first embodiment. Specifically, a relative displacement L3 is calculated according to the absolute coordinate X3 (generated from the touch device 20) and the reference point O, and transformed into a corresponding relative coordinate Y3 of the portable terminal 30. Next, the corresponding relative coordinate Y3 is transmitted to the portable terminal 30 over a wireless link, thereby moving the cursor on the screen 31 of the portable terminal 30 close to the icon F1. In the second stage of the control mechanism, the touch device 20 may detect the end point of the press track 25 to generate the absolute coordinate X4, calculate a slide displacement L4 between the start point and the end pint of the press track 25, and transform the slide displacement L4 into a slide relative coordinate Y4 of the portable terminal 30 according to the ratio between the screen resolution of the touch device 20 and the screen resolution of the portable terminal 30. Next, the touch device 20 may transmit the slide relative coordinate Y4 to the portable terminal 30 over the wireless link, and refer to the slide relative coordinate Y4 to move the cursor on the screen 31 of the portable terminal 30 from a position of the corresponding relative coordinate Y3 to the icon F1. Hence, the touch device 20 may control the portable terminal 30 to activate the icon F1.

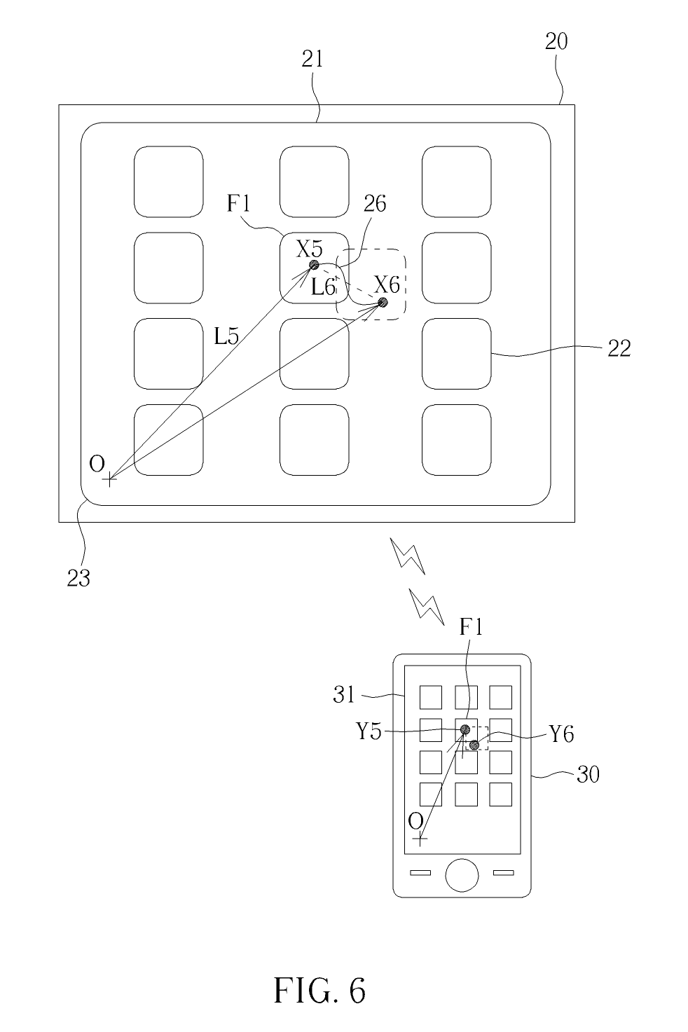

Please refer to FIG. 6, which is a diagram illustrating exemplary cursor movements of a touch device and a portable terminal according to a second embodiment of the present invention. The aforementioned press-and-slide may be used to move a position of an icon. In a case where a user presses the icon F1 on the touch screen 21 of the touch device 20, the touch device 20 may generate an absolute coordinate X5 and a relative displacement L5 of the cursor according to the control mechanism described in the first embodiment. The touch device 20 may transform the relative displacement L5 into a corresponding relative coordinate Y5 of the portable terminal 30 in order to control the cursor on the screen 31 of the portable terminal 30 to activate the icon F1. If the user keeps pressing the touch screen 21 to form a press track 26 of a press-and-slide, the touch device 20 may detect an end point of the press track 26 to generate an absolute coordinate X6. Additionally, the touch device 20 may calculate a slide displacement between a start point and the end point of the press track 26, transform the slide displacement L6 into a slide relative coordinate Y6 of the portable terminal 30, and transmit the slide relative coordinate Y6 to the portable terminal 30. Hence, the icon F1 may be moved from the corresponding relative coordinate Y5 to the slide relative coordinate Y6.

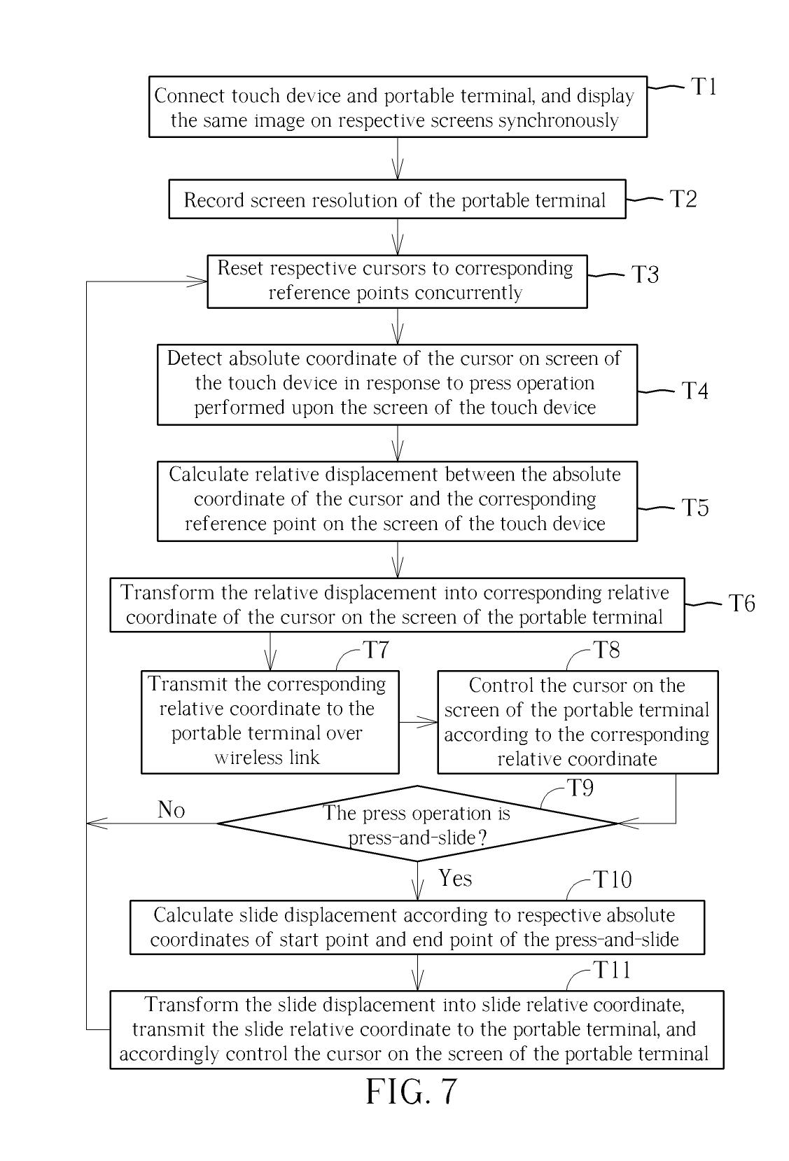

Please refer to FIG. 7, which is a flowchart of an exemplary method for controlling a portable terminal by a touch device according to a second embodiment of the present invention. Steps T1-T8 shown in the second embodiment are identical to that shown in the first embodiment, respectively. The exemplary method may be described in detail below.

Step T1: Connect the touch device and the portable terminal, and display the same image on respective screens of the touch device and the portable terminal synchronously.

Step T2: Use the touch device to record a screen resolution of the portable terminal.

Step T3: Reset respective cursors on the screens of the touch device and the portable terminal to corresponding reference points concurrently.

Step T4: Detect an absolute coordinate of the cursor on the screen of the touch device in response to a press operation performed upon the screen of the touch device.

Step T5: Calculate a relative displacement between the absolute coordinate of the cursor and the corresponding reference point.

Step T6: Transform the relative displacement into a corresponding relative coordinate of the cursor on the screen of the portable terminal according to a ratio between a screen resolution of the touch device and the screen resolution of the portable terminal.

Step T7: Transmit the corresponding relative coordinate to the portable terminal over a wireless link.

Step T8: Control the cursor on the screen of the portable terminal according to the corresponding relative coordinate.

Step T9: Determine whether the press operation is a slide-and-press. If the press operation is a tapping press rather than the slide-and-press, return to step T3 to reset the respective cursors on the screens of the touch device and the portable terminal to corresponding reference points before a next press operation; if the press operation is the slide-and-press, go to step T10.

Step T10: Calculate a slide displacement according to respective absolute coordinates of a start point and an end point of the press-and-slide.

Step T11: Transform the slide displacement into a slide relative coordinate of the portable terminal according to the ratio of between the screen resolution of the touch device and the screen resolution of the portable terminal, transmit the slide relative coordinate to the portable terminal, and refer to the slide relative coordinate to move the cursor on the screen of the portable terminal from the corresponding relative coordinate. Next, return to step T3 before a next press operation.

The proposed method for controlling the portable terminal by the touch device according to the second embodiment may determine whether the press operation is the tapping press or the slide-and-press. When a press position on the touch screen of the touch device is incorrect, the press position may be corrected by the slide-and-press. In addition to performing the tapping press upon a start point of the slide-and-press, the touch device may correct the press position (or move the icon) according to the slide displacement between the absolute coordinate of the start point and the absolute coordinate of the endpoint of the slide-and-press, thus facilitating control of the portable terminal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a portable terminal by a touch device, comprising:
connecting the touch device to the portable terminal, and using the touch device to record a screen resolution of the portable terminal;
displaying the same image on a screen of the touch device and a screen of the portable terminal synchronously;
resetting respective cursors on the screens of the touch device and the portable terminal to corresponding reference points concurrently;
detecting an absolute coordinate of the cursor on the screen of the touch device in response to a press operation performed upon the screen of the touch device;
calculating a relative displacement between the absolute coordinate of the cursor and the corresponding reference point on the screen of the touch device;
transforming the relative displacement into a corresponding relative coordinate of the cursor on the screen of the portable terminal;
transmitting the corresponding relative coordinate to the portable terminal over a wireless link;
controlling the cursor on the screen of the portable terminal according to the corresponding relative coordinate; and
resetting the respective cursors on the screens of the touch device and the portable terminal to the corresponding reference points concurrently.

2. The method of claim 1, wherein each reference point is a predetermined point or an origin point on the corresponding screen.

3. The method of claim 1, wherein the step of transforming the relative displacement into the corresponding relative coordinate of the cursor on the screen of the portable terminal comprises:
transforming the relative displacement into the corresponding relative coordinate according to a ratio between a screen resolution of the touch device and the screen resolution of the portable terminal.

4. The method of claim 1, wherein the press operation is a press-and-slide or a tapping press; a start point and an end point of the press-and-slide correspond to different absolute coordinates on the screen of the touch device; and a start point and an end point of the tapping press correspond to the same absolute coordinate on the screen of the touch device.

5. The method of claim 4, wherein after the cursor on the screen of the portable terminal is controlled according to the corresponding relative coordinate, the method further comprises:
determining whether the press operation is the press-and-slide according to absolute coordinates of a start point and an end point of the press operation.

6. The method of claim 5, wherein when it is determined that the press operation is not the press-and-slide, the step of resetting the respective cursors on the screens of the touch device and the portable terminal to the corresponding reference points concurrently is executed.

7. The method of claim 5, wherein when it is determined that the press operation is the press-and-slide, the method further comprises:
calculating a slide displacement according to the absolute coordinates of the start point and the end point of the press-and-slide;
transforming the slide displacement into a slide relative coordinate of the cursor on the screen of the portable terminal;
transmitting the slide relative coordinate to the portable terminal over a wireless link; and
after the cursor on the screen of the portable terminal is controlled to move to a position according to the corresponding relative coordinate, referring to the slide relative coordinate to move the cursor on the screen of the portable terminal from the position.

8. The method of claim 7, wherein the step of transforming the slide displacement into the slide relative coordinate of the cursor on the screen of the portable terminal comprises:
transforming the slide displacement into the slide relative coordinate according to a ratio between the screen resolution of the touch device and the screen resolution of the portable terminal.

9. The method of claim 7, further comprising:
correcting a press position of the press-and-slide from the start point of the press-and-slide to the end point of the press-and-slide.

10. The method of claim 7, further comprising:
moving an icon located at the start point of the press-and-slide to a position corresponding to the end point of the press-and-slide.

11. The method of claim 1, wherein the touch device is a large size television including a touch screen or an on-board unit including a touch screen.

12. The method of claim 1, wherein the portable terminal is a mobile phone or a tablet computer.

13. The method of claim 1, wherein the portable terminal is an apparatus running an Android operating system.

14. The method of claim 1, wherein the portable terminal stores an application executable file while the touch device does not store the application executable file.

15. The method of claim 1, wherein the wireless link is a bluetooth link.
